(19) United States
(12) Patent Application Publication
(10) Pub. No.: US 2008/0290717 A1
(43) Pub. Date: Nov. 27, 2008

(54) SEATBELT PULLING TOOL

(76) Inventor: Charles R. Klapp, Harrison Township, MI (US)

Correspondence Address: CARGILL & ASSOCIATES, P.L.L.C., 56 MACOMB PLACE, MT. CLEMENS, MI, 48043, US

(21) Appl. No.: 11/941,001

(22) Filed: Nov. 15, 2007

Related U.S. Application Data
(60) Provisional application No. 60/865,882, filed on Nov. 15, 2006.

(51) Int. Cl. B60R 22/00

(52) U.S. Cl. 297/468

(57) ABSTRACT

There is provided a “threadable” seatbelt pulling tool adapted to be releasably secured to a male engagement plate of a seat belt buckle for aiding in the endeavor of securing a child restraint safety seat within a vehicle. In one aspect of the present seatbelt pulling tool, the tool facilitates the extension of the seat belt through the frame of a child safety restraint, so that the male engagement plate of the seat belt buckle can be coupled with the mating female buckle of the seat belt to secure the child safety restraint to the seat of the vehicle. In a second aspect of the present invention, for new motor vehicles, an aperture is provided in the seatbelt pulling tool to accommodate the new “latch” system design of seat restraining belts to be threaded through the frame of a child safety restraint.

### BACKGROUND OF THE INVENTION

1. Field of the Invention

This invention relates to a tool that assists in the installation of a child safety restraint seat of the type designed to rest on a vehicle seat. More particularly, the invention relates to a seatbelt pulling tool to assist a person installing child safety restraint seat to be secured to the vehicle seat by a vehicle seatbelt which passes through the child safety restraint seat.

2. Description of the Prior Art

Child safety is an increasingly more and more important aspect of transportation of children in vehicles. Therefore, child safety restraint seats are required by law to be utilized for children in order to prevent them from injury in the event of an accident. These laws have been enacted nationwide, and for smaller children, it is the law that requires all drivers desiring to transport a child to have a child safety restraint seat in proper position with the seatbelt provided by the automotive manufacturer. In this way, the children are “buckled up” to achieve the same level of safety through safety belts as there adult counterparts.

However, problems have arisen because the restraint seats are relatively expensive, and a family may only be able to afford one restraint seat and have to shift the restraint seat from vehicle to vehicle depending on who is transporting the child. To further complicate the situation, grandparents and child care workers may also need to transport the child. This means that the restraint seat needs to be shifted from vehicle to vehicle to vehicle during the normal transportation of the child.

A problem arises because threading the seatbelt through the child restraint seat is difficult, as the openings to receive the safety belt itself are mandated by law to be of a certain size. This size is predetermined to allow less “slop” of the belt in the seatbelt opening, such that during an accident, the seatbelt is only allowed a certain amount of travel. It is a very frustrating operation to thread the seatbelt through the restraint seat over and over again during a single days drive for a first parent to drop a child off at a child care worker facility, have the child care worker transport the child to a second location, perhaps even a second child care worker transport the child back to the first facility, and have the second parent, in his or her own vehicle, pick the child up from the daycare facility only to have to use the restraint seat again in order to transport the child back home. As the seat may be sized for that particular weight class of child it is possible that the car seat will have to be moved four different times, and resecured to each vehicle.

The problem that arises is because conventional child safety restraint seats include a transverse channel or path in a base or frame for receiving a seat belt in a tie-down arrangement. A male engagement plate of the seat belt buckle passes through the child safety restraint seat and is coupled to a mating female buckle on the other side, thereby securing the child safety restraint seat to the vehicle. Usually, the transverse channel or path, through which the male half of the seat belt buckle and fabric belt must pass, is smaller than a person's hand or arm. Therefore, the transverse channel or path is not a straight smooth path for the seat belt to traverse. This makes it difficult to thread the seat belt through the child safety restraint seat and to secure the safety seat to the seat of a vehicle.

Various aids for threading a seat belt through a child safety restraint seat have been developed. For example, U.S. Pat. No. 5,197,176 issued to Reese shows one such design. The device of Reese is designed so that the male engagement plate of the seat belt must go past the hinged/base end of the hook, past the point of the hook, and then back to the hinged/base end in order for it to be engaged. This arrangement makes the device of Reese difficult to use. Furthermore, in this device, the hinged/base end of the hook must be smaller than the hole in the male engagement plate of the seat belt. Because the holes used in the design of many of the male engagement plates used in vehicles today are quite small, the hook of the Reese device also must be made very small to accommodate different male engagement plates. When the hooks are made so small, the hook member will have insufficient strength and durability needed for repeated use. On the other hand, if the hook is able to be made small with sufficient strength, it becomes difficult for the male engagement plate to be released from the hook.

Therefore, there is a need in the art for a seatbelt pulling tool to assist a user in installing a child safety restraint seat in a vehicle that is strong, durable, inexpensive, easy to use, and easy to produce.

### SUMMARY OF THE INVENTION

In accordance with the present invention, there is provided a “threadable” seatbelt pulling tool adapted to be releasably secured to a male engagement plate of a seat belt buckle for aiding in the endeavor of securing a child restraint safety seat within a vehicle. In one aspect of the present seatbelt pulling tool, the tool facilitates the extension of the seat belt through the frame of a child safety restraint, so that the male engagement plate of the seat belt buckle can be coupled with the mating female buckle of the seat belt to secure the child safety restraint to the seat of the vehicle.

In a second aspect of the present invention, for new motor vehicles, an aperture is provided in the seatbelt pulling tool to accommodate the new “latch” system design of seat restraining belts to be threaded through the frame of a child safety restraint.

### BRIEF DESCRIPTION OF THE DRAWINGS

For a further understanding of the nature and advantages of the expected scope and various embodiments of the present invention, reference shall be made to the following detailed description, and shall be taken in conjunction with the accompanying drawings, in which like parts are given the same reference numerals, and wherein:

FIG. 1 is a perspective view of a first embodiment of the invention made in accordance with the present invention;

FIG. 2 is a top view of the seatbelt pulling tool of FIG. 1;

FIG. 3 is a perspective view of a second embodiment of the seatbelt pulling tool of the present invention;

FIG. 4 is a perspective view of the seatbelt pulling tool of FIG. 1 engaged with a male engagement plate of a seat belt locking assembly;

FIG. 5 is a side edge view showing the engagement between the seatbelt pulling tool and the male engagement plate of the seat belt locking assembly in more detail;

FIG. 6 is a top perspective view of another aspect of the seatbelt pulling tool made in accordance with the present invention;

FIG. 7 is a top perspective view of another aspect of the seatbelt pulling tool made in accordance with the present invention;

FIG. 8A shows the aspect of FIGS. 6 and 7 engaged with a male engagement plate of a seatbelt locking assembly from an original equipment manufacturer; and

FIG. 8B is a top plan view of a seatbelt pulling tool of FIG. 6 or 7 engaged with an engagement latch provided in newer model car seats by original equipment manufacturers.

### DETAILED DESCRIPTION OF THE INVENTION

The seatbelt pulling tool of the present invention is adapted to be releasably secured to a male engagement plate of a seat belt buckle. The seatbelt pulling tool facilitates the extension of the seat belt through the frame of a child safety restraint, so that the male engagement plate of the seat belt buckle can be coupled with the mating female buckle of the seat belt to secure the child safety restraint to the seat of the vehicle.

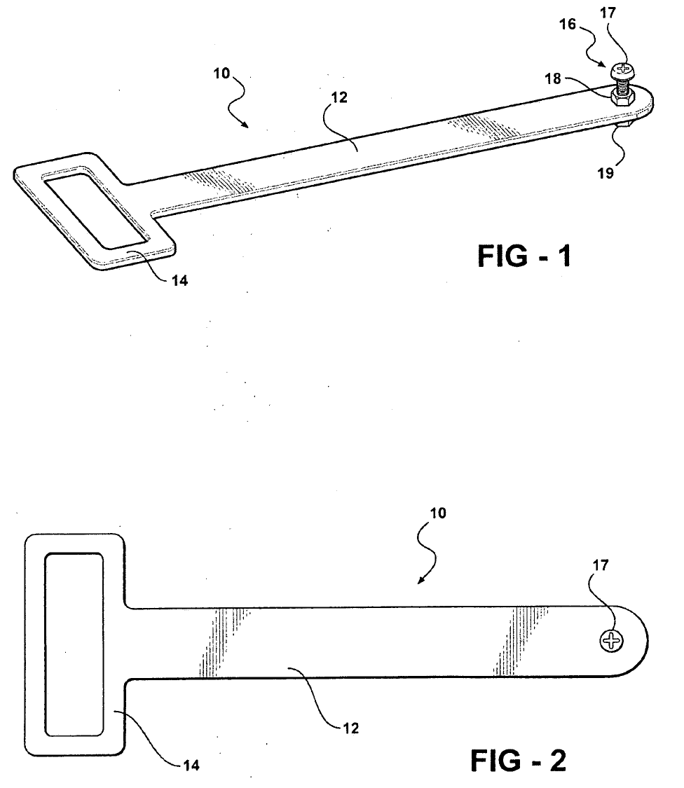

FIG. 1 is a perspective view of a first embodiment of the seatbelt pulling tool made in accordance with the present invention. The seatbelt pulling tool, generally indicated by the numeral 10, includes an elongated body 12 with a handle 14 at one end and a protruding rivet, generally indicated by the numeral 16, at the other end.

Generally, seatbelt pulling tool 10 is formed from a single length of suitable material, such as metal, plastic, wood, cardboard, rubber or the like. Preferably, the seatbelt pulling tool 10 is made of thin, lightweight, flexible plastic or cardboard material. The handle 14 is sized and shaped to be gripped comfortably by an average adult hand, especially a female adult.

The seatbelt pulling tool 10 according to the invention can be appropriately shaped and dimensioned so as to provide the desired degree of strength and flexibility while making the device easy to produce and use and readily adaptable for use with a variety of different vehicles and safety seats. For example, elongated body 12 and the handle 14 may have a variety of different shapes and dimensions without departing from the invention. Therefore, in this embodiment, those of ordinary skill in the art will be able to determine appropriate shapes and dimensions for each of the components.

In this aspect, the protruding rivet 16 includes a bolt 17 screwed into the elongated body 12 through nuts 18 and 19, respectively. While the bolt 17 is utilized to hook the male engagement plate of the seat belt buckle, nuts 18 and 19 keep the bolt 17 fastened to elongated body 12. The protruding rivet 16 only illustrates one aspect of a preferred embodiment of the invention. Those skilled in the art will recognize, however, that various changes and modifications can be made to this specifically illustrated design without departing from the invention. FIG. 2 is a top view of the seatbelt pulling tool of FIG. 1, which shows a clear and sharp design of the seatbelt pulling tool 10.

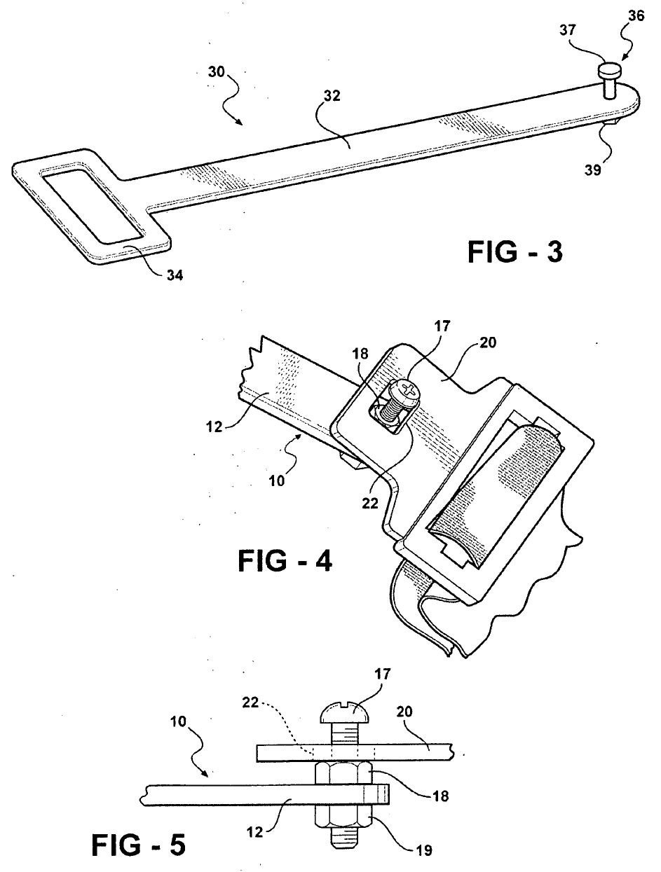

FIG. 3 shows a second embodiment of the seatbelt pulling tool of the present invention. The seatbelt pulling tool, generally indicated by the numeral 30, includes an elongated body 32 with a handle 34 at one end and a protruding means, generally indicated by the numeral 56, at the other end. The elongated body 32 and handle 34 have similar shape, size and dimension as those in the first embodiment as shown in FIG. 1. Although many different types of protrusions would be suitable, protruding means 36 may be a post 37 having a cap on the top as shown in FIG. 5. Post 37 may be fastened to the elongated body 32 by a nut 39. In addition, the inventor envisions that various changes and modifications can be made to this specifically illustrated protruding means without departing from the invention, as long as the protruding means may be able to capture the male engagement plate of the seat belt buckle.

FIG. 4 is a perspective view of the seatbelt pulling tool 10 of FIG. 1 engaged with a male engagement plate 20 of a seat belt locking assembly. The male engagement plate 20 includes a hole 22. When the seatbelt pulling tool 10 is employed for engaging male engagement plate 20, the protruding rivet 16 protrudes through the hole 22 in male engagement plate 20 and is securely held in place by the bolt 17.

FIG. 5 shows the engagement in more detail. When the seatbelt is engaged with seatbelt pulling tool 10, it is much easier to pull the male engagement plate to pass through a transverse channel or path of the child safety restraint seat. Therefore, the male engagement plate can be coupled with the mating female buckle of the seat belt to further secure the child safety restraint seat to the seat of the vehicle. In addition, after the seatbelt pulling tool pulls the seat belt, it is also easy to release the male engagement plate from the seatbelt pulling tool by tilting the seatbelt pulling tool.

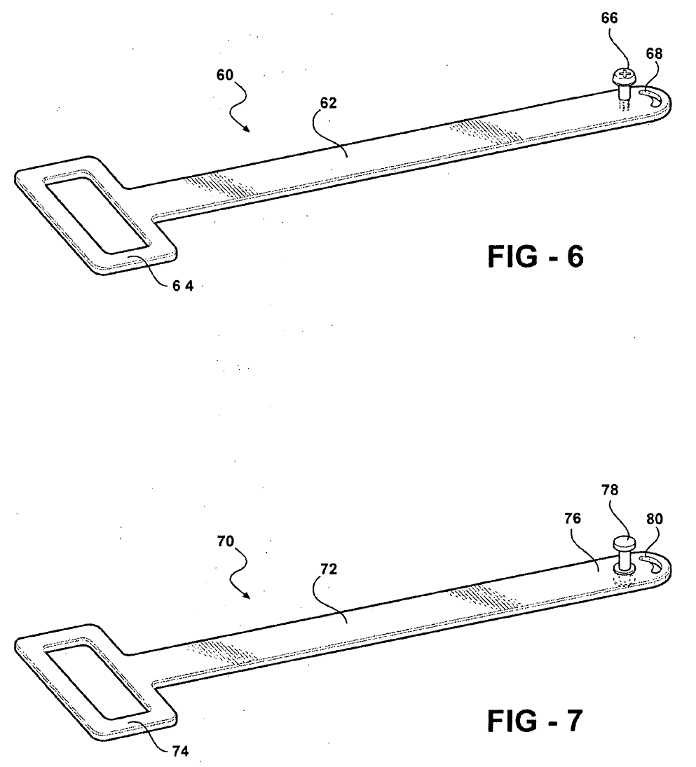

FIG. 6 illustrates another aspect of the present invention of a seatbelt pulling tool made in accordance with the present invention. This aspect of the seatbelt pulling tool generally indicated by the numeral 60, includes an elongated body 62 with a handle 64 at a distal end, and a protruding screw 66 at the opposite end. An aperture 68 is at the same end as screw 66, and may be utilized in newer car seat models, which incorporate a latch mechanism in the seat assembly. These latch mechanisms come from the original equipment manufacturer (OEM), and are designed to hold down new and different types of car seats for child restraint. The latch system is permanently installed on the car seat. The newer car seats optionally have the latch system installed on the seat which can be directly held and restrained within the vehicle. However, for current model car seats that do not include the latch system, screw 66 may engage the male engagement plate of a standard seatbelt for any car made before 2007.

FIG. 7 illustrates yet another aspect of the present invention, wherein the seatbelt pulling tool is generally denoted by the numeral 70, including an elongated body 72 with a handle 14 at one end and a protrusion means 78 and aperture 80 at the other end. The protrusion means 78 is a rivet which is more easily attached than some of the other fasteners shown in earlier aspects, and the aperture is sized to receive the distal end of the latch system of the newer seats.

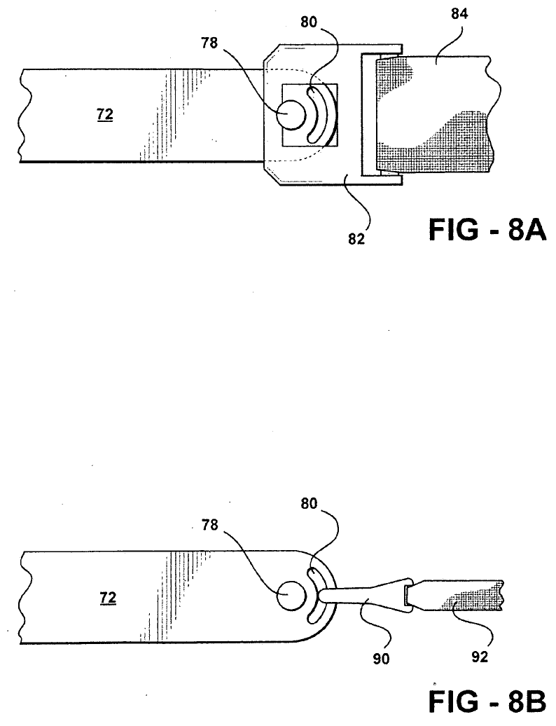

Looking next to FIG. 8A, there is shown a top plan view similar to that shown in FIG. 4, in which the rivet protrusion means 78 attached to elongated body 72 is used to capture male engagement plate 82 attached to seatbelt 84.

On the other hand, FIG. 8B shows the seatbelt pulling tool of FIG. 7, with an elongated body 72 and protrusion means 78 nearby aperture 80. Latch system 90 attached to seatbelt 92 hooks through aperture 80 and may thereafter be pulled through the newer style of child restraint seat, as seatbelt 92 needs to be threaded through the back of the child restraint seat in order to provide safety for the child being carried therein in the event of an accident.

The seatbelt pulling tool of the present invention overcomes the weakness of the prior art and provides many advantages. First, the seatbelt pulling tool of the present invention makes the installation of child safety restraint seats easy. Second, the seatbelt pulling tool has a simple design that is easy to assemble in any household. Third, the seatbelt pulling tool has a standard size, which is compatible with many different styles and sizes of the male seat belt engagement plate. The protruding rivet of the seatbelt pulling tool is able to hook the hole in any male seat belt engagement plate, no matter how small or large the hole is. Fourth, the seatbelt pulling tool is easy to use for both engaging with and releasing from the male seat belt engagement plate. Fifth, the seatbelt pulling tool may be manufactured at low cost. Sixth, the seatbelt pulling tool has a simple, one-piece design. Seventh, the seatbelt pulling tool has a thin, flat design that lends itself to easy storage within the seat or the vehicle.

While the seatbelt pulling tool of the present invention is useful in securing a single child safety restraint seat to a seat in a vehicle, it is especially useful when more than one child safety restraint seat is placed adjacent to each other and the seat belt must be extended and guided through such child safety restraint seats to secure them to the seat in the vehicle.

Furthermore, the foregoing seatbelt pulling tool of this invention lends itself to securing not only child safety restraints, but to a variety of objects without departing from the inventive concept or detracting from the operating advantages of the device.

While the physical dimensions of the tool are not critical, such tool should have dimensions which would allow it to be easily used for its intended purpose and yet be of a convenient size for storage. For example, the entire length of the tool may be from 10 to 16 inches in length, where the elongated body of the tool may be up to 3 inches in width. The protruding means in any of the aspects would be from ¼″ to 1″ from the end of the elongated body, while any aperture embodiment would place the aperture within about 2 inches from the end so as to accommodate the new latch system hook.

In summary, numerous benefits have been described which result from employing any or all of the concepts and the features of the various specific embodiments of the present invention, or those that are within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated.

1. A seatbelt pulling tool adapted to be releasably secured to a male engagement plate of a seat belt buckle for aiding in the endeavor of securing a child restraint safety seat within a vehicle, comprising:
an elongated body having a distal end and a proximal end;
a protruding means at the distal end for engaging the male engagement plate of the seat belt buckle, said protruding means being adapted for threading the coupled seat belt buckle through the frame of a child safety restraint;
a handle at the proximal end of the tool to facilitate the extension of the seat belt through the frame of a child safety restraint, so that the child safety restraint seat is secured to the seat of the vehicle.
